(19) United States
(12) Patent Application Publication
(10) Pub. No.: US 2020/0332916 A1
(43) Pub. Date: Oct. 22, 2020

(54) METERING DEVICE AND METHOD FOR METERING LIQUID MEDIA

(71) Applicant: DELO INDUSTRIE KLEBSTOFFE GMBH & CO. KGAA, Windach (DE)

(72) Inventors: Wolf-Dietrich HEROLD, Windach (DE); Thomas HAEMMER, Windach (DE)

(21) Appl. No.: 16/762,728

(22) PCT Filed: Nov. 6, 2018
(86) PCT No.: PCT/EP2018/080360

§ 371 Date: May 8, 2020

(30) Foreign Application Priority Data
Nov. 9, 2017 (DE) 10 2017 126 307.1

(51) Int. Cl. F16K 31/365

(52) U.S. Cl. CPC F16K 31/365

(57) ABSTRACT

Metering device (10) for metering liquid media is described comprising a valve element (24) and a valve seat (22) allocated to the valve element (24). The valve element (24) blocks an opening (20) allocated to the valve seat (22) in a closed position of the metering device (10), through said opening (22) the liquid medium flows in an open position of the metering device (10). The metering device (10) includes a membrane (28) serving as an actuator (26) that is designed rigidly flexibly and is coupled to the valve element (24) in order to adjust the valve element (24). The membrane (28) comprises at least partially a structuring (34). The metering device (10) includes a pneumatic actuator unit (14) so that the membrane (28) serving as an actuator (26) is operated pneumatically, wherein the membrane (28) is sealed against the medium to be metered. Moreover, a method for metering liquid media is described.

### FIELD OF THE INVENTION

The invention relates to a metering device for metering liquid media, in particular adhesives. Moreover, the invention relates to a method for metering liquid media, in particular adhesives.

### TECHNICAL BACKGROUND

Various methods are commonly known in the field of metering viscous media; in said methods, the medium can be metered in the form of free-floating drops.

U.S. Pat. No. 5,729,257 A describes, for example, a method for metering ink from a print head using what is termed the “drop-on-demand” method. In this method, tiny vapor bubbles are generated explosively by strongly heating the metering medium, said vapor bubbles leaving the print head in the form of free-floating ink drops.

In contrast to this, U.S. Pat. No. 8,257,779 B2 discloses what is termed a jetting method in which liquid media can be dispensed via a pneumatically actuated valve needle from the device.

The aforementioned metering device can meter in a contactless manner, without needing to set down on the substrate. This enables generally high metering frequencies, shorter cycle times and the precisely positioned metering in industrial manufacturing processes.

The additional requirements for the metering device depend heavily on the viscosity and the surface tension of the medium to be metered. In some cases, media with a low viscosity does not require any external pressure to transport this into the metering chamber of the metering device. Moreover, a relatively low momentum is necessary to overcome the surface tension on the outlet opening and to generate a free-floating drop. However, the higher the viscosity of the media to be metered is, the stronger the cohesive forces are that need to be overcome. Ideally, the momentum is generated with a valve needle directly on the outlet opening in order to minimize energy loses as a result of attenuation. Frequently, the valve needle also simultaneously has the function of closing the metering device in its non-operative state.

Various principles are known in the prior art to move a valve needle and generate a pressure pulse.

Piezoelectrically actuated ceramic elements, such as disclosed in EP 1 414 080 B1, can be operated by applying an electric voltage. The limited expansion of the ceramic when applying a voltage, however, results in small strokes, which is why transmission via a lever system is required. Such transmission requires very low production tolerances, limits the longevity of piezo-driven actuators and considerably increases the masses moved.

In the case of the pneumatic metering device such as described in EP 0 861 136 B1, a piston connected to a pneumatic valve actuates a valve needle. The piston is forced counter to its direction of effective motion by injecting compressed air. A spring which is prestressed is used in the design described. When subsequently venting through the compressed air valve, the spring assist on the valve needle returns the valve needle to its starting position at high speed. In doing so, the valve needle generates a pressure pulse in the medium to be metered.

DE 10 2013 006 106 A1 shows a metering device with bellows into which compressed air is admitted and which actuate a traverse connected to the valve needle according to the principle described above. In addition, a switchable magnetic element is provided that is to increase the restoring force of the spring further. The disadvantage of this embodiment is that a large venting volume occurs when using the bellows, said venting volume limiting in particular the switching times in connection with the preceding pressure valve.

### ABSTRACT OF THE INVENTION

The object of the invention is to overcome the disadvantages of the prior art and to provide a metering device that is capable of metering liquid media efficiently and economically, in particular adhesives with their special properties.

The object is solved according to the invention by means of a metering device for metering liquid media, comprising a valve element and a valve seat allocated to the valve element, wherein the valve element in a closed position of the metering device blocks an opening that is allocated to the valve seat, through said opening the liquid medium flows in an open position of the metering device, wherein the metering device includes a membrane serving as an actuator that is designed rigidly flexibly and is coupled to the valve element in order to adjust the valve element, wherein the membrane comprises at least partially a structuring and wherein the metering device comprises a pneumatic actuator unit so that the membrane serving as an actuator is operated pneumatically, wherein the membrane is sealed against the medium to be metered.

Furthermore, the object is solved according to the invention by means of a method for metering liquid media, in particular adhesives, in said method compressed air is applied to a membrane of a metering device serving as an actuator via a pneumatically operated actuator unit so that the membrane and a valve element that is coupled to the membrane and allocated to a valve seat of the metering device are pneumatically adjusted in order to release or lock an opening allocated to the valve seat.

The basic idea of the invention is to achieve a high efficiency of the metering device by transferring the momentum generated via the pneumatic actuator unit to the medium to be metered without frictional losses and by providing a large active area over the membrane. As a result of the high level of efficiency, corresponding cost advantages can be attained as compressed air is relatively expensive in comparison to electricity. By means of the metering device according to the invention, high momentum entries can be realized in the medium to be metered at low input pressures via the valve element, wherein it does not require complex and expensive pressure infrastructure preceding the metering device, as otherwise normal is, if the momentum entry into the medium to be metered is to be increased by means of higher input pressures in the case of a small active area.

As the membrane is sealed against the medium to be metered, it ensures that the membrane does not come into contact with the medium to be metered.

Furthermore, the nearly massless actuator formed by the membrane is durable and wear-resistant, wherein it is suitable for jetting highly viscous materials, for example adhesives, at the same time.

The knowledge on which the invention is based is to also provide a large active area of the actuator on which the pressure pulse is transmitted, thereby keeping the necessary supply pressure as low as possible. This can be achieved, inter alia, via the membrane and the surface of the membrane which is modified as a result of the structuring of the membrane and which serves as the active area. At the same time, it thus avoids having to increase the construction of the membrane serving as an actuator, which would impact negatively on the integrability of such a metering device in industrial manufacturing systems. A high metering frequency can be achieved with the metering device according to the invention as the times for supplying and venting air can be kept short.

The metering device is, for example, a metering device for adhesives. By means of the metering device, adhesive can thus be metered easily.

In this respect, the metering device can be used as a metering device for adhesives.

An aspect provides that the membrane comprises a first side and a second side opposite the first side, wherein the first side is allocated to a pressure chamber and/or wherein the second side is allocated to a movement chamber, in particular wherein the movement chamber has a flow connection with the environment via openings so that the pressure in the movement chamber corresponds to the atmospheric pressure. Accordingly, in the case of pneumatic actuation, the membrane can move into the movement chamber which can be provided on the side of the membrane opposite the pressure chamber. An increase in pressure in the pressure chamber thus results in a movement of the membrane in the movement chamber. The movement chamber is sealed from the pressure chamber so that a pressure difference on both sides of the membrane can be generated via the pneumatic actuator unit, in particular varying pressure differences in a pulsating manner.

The pneumatic actuator unit can be configured to apply compressed air to the membrane so that the pneumatic actuator unit (via the value element coupled to the membrane) exerts a momentum on the medium to be metered. In particular, the pneumatic actuator unit is configured to exert a high-frequency momentum sequence on the medium to be metered. To this end, compressed air is applied in a pulsating manner to the membrane, thereby resulting in a pulsating movement of the valve element coupled to the membrane.

To this end, the metering device can include a control device that is connected to the pneumatic actuator unit in signal-transmitting manner in order to transmit control commands to the pneumatic actuator unit.

In general, the pulsating actuation of the membrane (and of the value element coupled to the membrane) results in the amount of the medium to be metered being metered very precisely. This is important for expensive media to be metered, for example adhesives.

Another aspect provides that the membrane is formed, in particular embossed, in the area of the structuring. In this respect, the structuring of the membrane can be realized economically and more easily as it is subsequently provided mechanically.

In particular, the pressure chamber comprises a counter structuring on a side opposite to the membrane, said counter structuring being complementary to the structuring of the membrane. As a result, the volume of the pressure chamber can be reduced, thereby making a rapid supply of air to and a rapid venting of the pressure chamber possible. The achievable metering frequency can be increased accordingly. Optionally, the movement chamber also comprises a complementary counter structuring.

The membrane can be undulated, wherein the wave peaks and wave troughs each alternate. The wave structure constitutes a particularly favorable structuring in order to be able to easily ensure the desired rigidity of the membrane and the required flexibility at the same time.

According to an embodiment, the membrane comprises a modulus of elasticity (Young's modulus) of greater than 50 GPa, preferably greater than 100 GPa and particularly preferably greater than 150 GPa, and/or the spring constant of the membrane is between 5 N/mm and 50 N/mm. Due to these parameters of the membrane, it is ensured that the membrane has the desired rigidity and at the same time the required flexibility during operation, in particular during the pulsating operation of the membrane.

The behavior of the membrane can be set accordingly during adjustment with regards to the differences in height of the wave peaks or wave troughs in relation to the middle plane of the membrane. Deeper wave troughs or higher wave peaks affect the spring constant of the membrane as more material is generally available to enable flexing with increasing depth or height.

Another aspect provides that the membrane is substantially circular and/or continuously closed, in particular wherein the membrane has a concentric wave geometry. This results in a rotationally symmetrical membrane that is adjusted accordingly uniformly, thus increasing the precision when metering the medium. The valve element coupled to the membrane is thus adjusted substantially homogeneously translationally upon actuation of the actuator.

In particular, the membrane comprises a centrally provided adjustment section and/or a structural section, particularly wherein the valve element is coupled to the membrane in the area of the adjustment section. The valve element is thus located centrally on the membrane so that it has a high repeatability during adjustment, thereby ensuring that a high metering frequency with a high degree of accuracy is possible. The mobility of the membrane is ensured via the structural section which surrounds the adjustment section, for example, annularly.

According to an embodiment, a spring element is provided, via which the membrane is prestressed, in particular wherein the spring element prestresses the membrane in the open position of the metering device or closed position of the metering device. This depends on the specific configuration of the spring element. The compressed air can be used accordingly in order to adjust the membrane in such a way that the metering device is in its closed position or its open position.

In general, the pressure of the compressed air acts counter to the spring force of the spring element to adjust the membrane accordingly.

In general, pulsating operation is possible with the metering device due to the correspondingly formed membrane, thus metering frequencies greater than 100 Hz, in particular greater than 200 Hz, when metering the medium in order to generate free-floating drops.

### BRIEF DESCRIPTION OF THE DRAWINGS

Additional advantages and features of the present invention can be found in the following description and the drawings to which reference is made. In the drawings:

FIG. 1 shows a metering device according to the invention according to a first embodiment in its closed position,

FIG. 2 shows a detailed view of the metering device according to the invention from FIG. 1,

FIG. 3 shows a metering device according to the invention from FIG. 1 in its open position,

FIG. 4 shows a detailed view of the metering device according to the invention from FIG. 3,

FIG. 5 shows a detailed view of the metering device according to the invention according to a second embodiment,

FIG. 6 shows a detailed view of the metering device according to the invention according to a third embodiment,

FIG. 7 shows a metering device according to the invention according to a forth embodiment in its closed position,

FIG. 8 shows a metering device according to the invention according to a fifth embodiment in its closed position, and

FIG. 9 shows a diagram with a force-distance curve of a structured membrane and a force-distance curve of a smooth membrane.

### DETAILED DESCRIPTION OF PREFERRED EMBODIMENTS

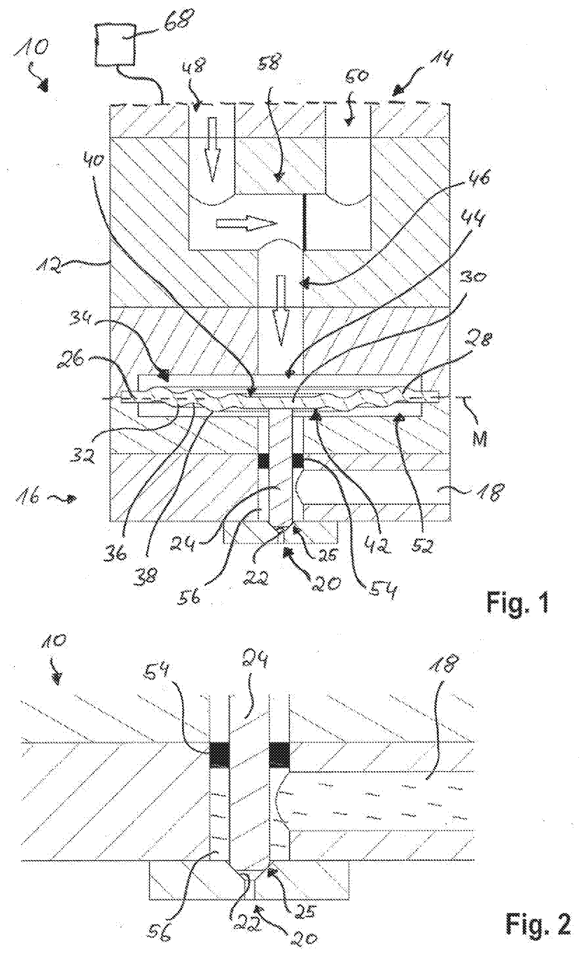

In FIG. 1, a metering device 10 is shown comprising a housing 12 and a pneumatic actuator unit 14.

The housing 12 comprises a media section 16 in which a media channel 18 for an adhesive to be metered and an outlet opening 20 that is in flow connection to the media channel 18 are provided, via said outlet opening the medium to be metered can exit.

A valve seat 22 is allocated to the outlet opening 20, said valve seat 22 interacting with a valve element 24 that is designed as a valve needle comprising a tip 25 pointing at the valve seat 22. The valve element 24 is coupled to an actuator 26 that comprises a membrane 28, via which the pneumatic actuator unit 14 can be pneumatically actuated, in particular in a pulsating manner, as will be explained below.

The membrane 28 is substantially continuously closed and circular, wherein it comprises a central adjustment section 30 over which the valve element 24 is coupled to the membrane 28. For example, the valve element 24 is coupled to the membrane 28 made of metal by means of a soldered joint, a welded joint or screw connection.

The connection between the membrane 28 and the valve element 24 can be carried out by means of methods such as soldering, welding or screwing. By these means, a long-lasting connection is ensured.

To produce the screw connection, the required screw element can extend through an opening in the membrane 28.

In the shown embodiment, the central adjustment section 30 surrounds a substantially annular structural section 32 of the membrane 28. Thus, the membrane 28 comprises at least partially a structuring 34 that has been introduced, for example, by means of a forming process, in particular by embossing the membrane 28 in the area of the structural section 32.

In the shown embodiment, the structuring 34 is formed in the structural section 32 formed by means of a wave geometry that comprises multiple waves, thus alternating wave troughs 36 and wave peaks 38 in relation to the middle plane M of the membrane 28.

As the membrane 28 is circular and the structural section 32 is annular, the wave geometry is concentric which means that the waves extend radially outwards from the center, i.e. a wave trough 36 encloses a wave peak 38 radially in each case and vice versa. Thus, in a top view of the membrane 28, the pattern of the structural section 32 corresponds to several concentric rings that are formed by the alternating wave troughs 36 and wave peaks 38.

In general, via the structuring 34 of the membrane 28, it can be ensured that the membrane 28 has the desired properties in terms of rigidity and elasticity (flexing ability) in order to be adjusted by means of the pneumatic actuator unit 14 and to return in its intended starting position (see FIG. 3), provided that no pressure is exerted on the membrane 28. This will be explained below.

The membrane 28 comprises a first side 40 and a second side 42 that is opposite the first side 40. The first side 40 of the membrane 28 is allocated to a pressure chamber 44, via which the pneumatic actuator unit 14 generates the pressure to adjust the membrane 28 or the actuator 26. The pressure chamber 44 is in a flow connection with the operational channel 46 in turn depending on the position of the pneumatic actuator unit 14 can be in a flow connection with an air supply channel 48 and an outlet air channel 50 to develop the different pressure ratios in the pressure chamber 44, as will be explained below.

Thus, the first side 40 constitutes an active area of the membrane 28 as pressure is applied to the first side 40 in order to adjust the membrane 28. The active area of the membrane 28 is increased accordingly owing to the structuring 34 of the membrane 28 in the structural section 32.

The second side 42 of the membrane 28 points however in the direction of a movement chamber 52 in which the membrane 28 can move, provided that the pneumatic actuator unit 14 applies pressure to the membrane 28, thus actuates pneumatically.

The movement chamber 52 is substantially impermeable to liquid so that the membrane 28 does not come into contact with the medium to be metered or the membrane 28 is sealed against the medium to be metered.

For example, a sealing element 54 is provided to this end. The sealing element 54 can be O-shaped so that it surrounds the valve element 24 annularly and is supported externally on a stroke channel 56 formed in the housing 12, in particular on the interior of the stroke channel 56.

The movement chamber 52 is in a flow connection to the environment, for example, via openings so that the pressure in the movement chamber 52 corresponds to the atmospheric pressure as neither compressed air via the pressure chamber 44 nor the medium to be metered passes into the movement chamber 52 as a result of the sealing element 54. Accordingly, the membrane 28 can move into the movement chamber 52 smoothly in the case of pneumatic actuation, said movement chamber 52 can be provided on the side of the membrane 28 opposite the pressure chamber 44. As a result, high metering frequencies are ensured.

In general, the pneumatic actuation unit 14 comprises a control element 58 which is only shown schematically in the Figures. The control element 58 ensures that the air supply channel 48 or the outlet air channel 50 is placed in flow communication with the operational channel 46 in order to set different pressure ratios in the pressure chamber 44 that are associated with the different operational modes of the metering device 10. To this end, the control element 58 can be operated, for example, electrically which is why a power supply for the control element 58 or the pneumatic actuation unit 14 is necessary. As a result of the electrical operation of the control element 58, low response times are ensured.

In the following, the functioning of the metering device 10 when metering an adhesive shall be explained, in particular in pulsating operation.

The metering device 10 is connected to a compressed air source and a power source which are both not shown in the Figures for the sake of clarity.

Overpressure is applied to the air supply channel 48 via the compressed air source, wherein the control element 58 of the pneumatic actuation unit 14 is supplied in general with a corresponding voltage in order to be able to power the control element 58 electrically.

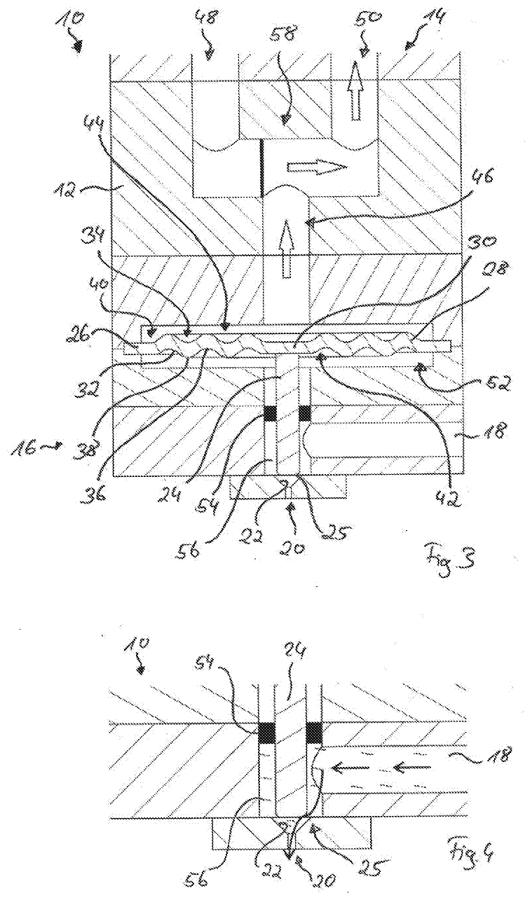

In FIG. 1, a starting position of the metering device 10 and of the control element 58 is shown in which a flow connection between the air supply channel 48 and the operational channel 46 is ensured so that pressure from the compressed air source is exerted on the membrane 28 via the air supply channel 48, the operational channel 46 and the pressure chamber 44 in order to act upon the valve element 24 in its closed position, which is shown in detail in FIG. 2.

In general, an overpressure is generated in the pressure chamber 44 as a result of the compressed air that flows into the pressure chamber 44 via the air supply channel 48 and the operational channel 46, said overpressure acting on the first side 40 of the membrane 28, thus the active area. The membrane 28 expands in the elastic region or contracts in the elastic region, thus in the area of the structuring 34, if a pressure difference is generated between the two sides 40, 42 by means of the compressed air. As a result, the membrane moves into the movement chamber 52. The corresponding movement of the membrane 28 is transmitted via the adjustment section 30 to the valve element 24 that is coupled to the membrane 28 so that is moved into its closed position, in which the tip 25 of the valve element 24 interacts with the valve seat 22 directly mechanically.

The movement of the value element 24 thus finishes with the valve element 24, in particular the tip 25, contacting the allocated valve seat 22 so that the outlet opening 20 is closed by the valve element 24 to prevent uncontrolled escaping of the adhesive via the media channel 18.

This position of the metering device 10 is also referred to as the lower end position as the valve element 24 is located in its lower position.

This closed position or the lower end position is set in particular if the control element 58 is not supplied with a voltage or a voltage breakdown occurs as long as a supply of compressed air is ensured. This makes sure that the medium to be metered via the media channel 18 does not escape via the outlet opening 20 uncontrollably. This constitutes, thus, what is termed a “fail-safe” property of the metering device 10.

Provided that the control element 58 of the pneumatic actuation unit 14 is now supplied with a voltage that causes a change in the state of the control element 58, the control element 58 closes the air supply channel 48 and opens the outlet air channel 50 so that a flow connection is set between the operational channel 46 and the outlet air channel 50. By this means, the overpressure located in the pressure chamber 44 is reduced, what can be also referred to as venting as the air located in the pressure chamber 44 can escape via the operational channel 46, the outlet air channel 50 and an outlet opening connected to the outlet air channel 50.

As a result, the elastically deformed membrane 28 destresses due to its resilient property with a decreasing pressure difference on both sides 40, 42 and can return to its original form (see FIG. 3). To this end, another control element that leads the membrane 28 actively back to its starting position is not necessary as this occurs as a result of the resilience of the membrane 28.

By means of the return movement of the membrane 28 into its original position or starting position, the valve element 24 coupled to the membrane 28 moves also, thereby moving this away from the valve seat 22 and thus opening the outlet opening 20.

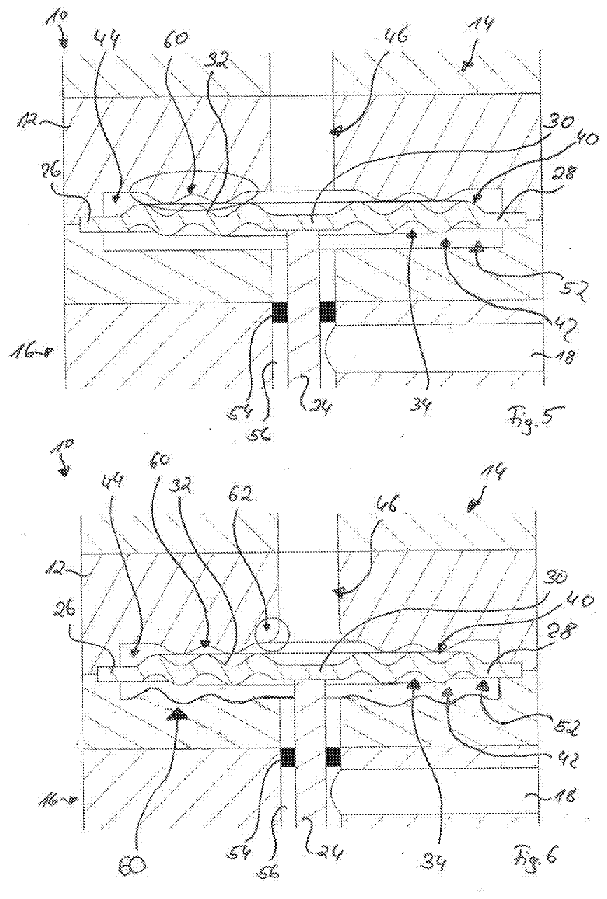

As a result, it is now possible that the medium can flow via the media channel 18 via the outlet opening 20, as is shown in particular in FIG. 4.

This position of the metering device 10, in particular of the valve element 24, is also referred to as the upper end position or open position.

The valve element 24 can thus be adjusted via the membrane 28, whereby the valve element 24 executes corresponding stroke movements between the both end positions, in particular in the pulsating operation of the metering device 10. A stroke corresponds to a movement from the lower end position to the upper end position, thus from the position shown into FIG. 1 to the position shown in FIG. 3.

The operating state of the metering device 10 or of the control element 58 lasts so long until the control element 58 is accordingly electrically actuated, thus another voltage or another voltage signal is applied.

From the upper end position shown in FIG. 3, the control element 58 is returned to the lower end position by applying (again) the first voltage signal or no more voltage being applied. As a result, the control element 58 and the metering unit 10 return to the starting position in which a flow connection is present between the air supply channel 48 and the operational channel 46. The overpressure in the pressure chamber 44 is thus generated anew, as already explained for FIG. 1.

The movement of the valve element 24 via the stroke is executed at a certain speed that is also referred to as the valve needle speed. It is important for the metering of the adhesive, what the valve needle speed is immediately before the impact of the valve element 14 on the valve seat 22, as the momentum produced is accordingly transmitted to the medium.

If the momentum produced on the medium is large enough, a free-floating drop can be generated, as is desired for the metering.

The speed of the valve element 24 particularly depends on the acceleration which correlates to the overpressure applied. Accordingly, it is possible to set the momentum entry via the pressure applied on the membrane 28. To set the overpressure which influences the pressure in the pressure chamber 44 and thus the pressure acting on the membrane 28, an external control unit can be provided, by means of which the speed of the valve element 24 can then be set indirectly.

An additional mechanical actuating element for controlling the valve needle speed is therefore not necessary. Accordingly, a mechanical set-up can be dispensed with, thereby saving on costs and construction space. Moreover, the set-up is independent of the mounting position, position and accessibility of the metering device 10.

In FIG. 5, a second embodiment of the metering device 10 is shown, in which the pressure chamber 44 is designed differently vis-à-vis the embodiments of the FIGS. 1 to 4.

The pressure chamber 44 comprises a counter structuring 60 that is provided on a side of the pressure chamber 44 which is opposite the membrane 28, in particular the first side 40 of the membrane 28 in the area of the structuring 34. Optionally, a counter structure can also be provided in the movement chamber 52.

In this regard, the counter structure 60 is designed correspondingly or complementary to the structuring 34, thereby enabling the volume of the pressure chamber 44 to be kept as low as possible. As a result, a rapid supply of air to and a rapid venting of the pressure chamber can be ensured so that high metering frequencies are possible.

To also easily ensure high metering frequencies, the air supply channel 48, the outlet air channel 50 as well as the operational channel 46 are designed as small as possible in particular in relation to the volume contained in the pressure chamber.

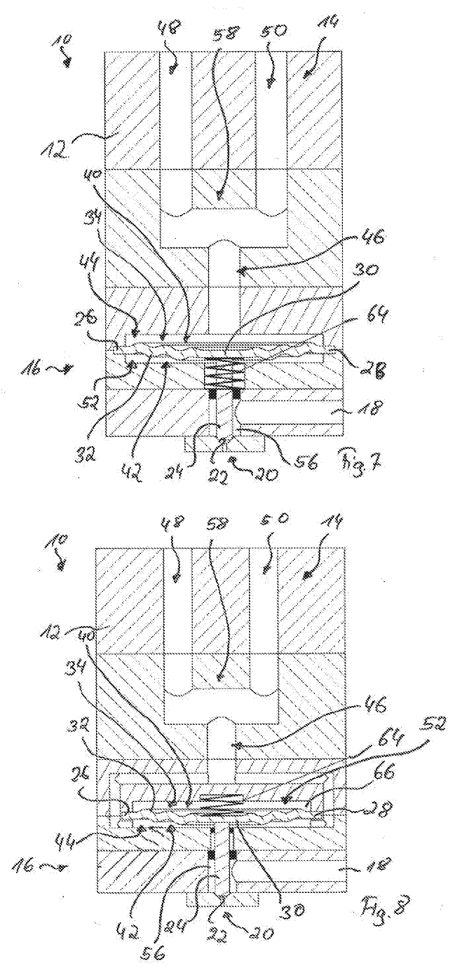

In FIG. 6, a further embodiment of the metering device 10 is shown, in which the operational channel 46 in the transitional region 62 to the pressure chamber 44 is rounded in order to avoid turbulent flows of the compressed air when supplying or venting air.

The rounding in the transitional region 62 ensures that abrupt jumps in diameter are avoided, thereby enabling laminar flows in the transitional region 62. To this end, the transitional region 62 is formed with a radius or a cone comprising an opening angle of 40° or more.

In FIG. 7, a further embodiment of the metering device 10 is shown that comprises a spring element 64 in addition to the embodiment shown in FIG. 1, said spring element 62 interacting with the membrane 28.

In the shown embodiment, the spring element 64 is located below the membrane 28, thus between the membrane 28 and the outlet opening 20.

In addition, the spring element 64 is designed as a compression spring that provides an additional restoring force for the membrane 28 if the membrane 28 is to return to its original position. Consequently, the spring element 64 supports the venting of the pressure chamber 44, thereby making more rapid venting cycles of the pressure chamber 44 realizable.

The spring element 64 is supported on the central adjustment section 30 of the membrane 28, in particular on the second side 42 of the membrane 28. At the other end, the spring element 64 is supported on an interior projection portion of the housing 12, in particular in the stroke channel 56.

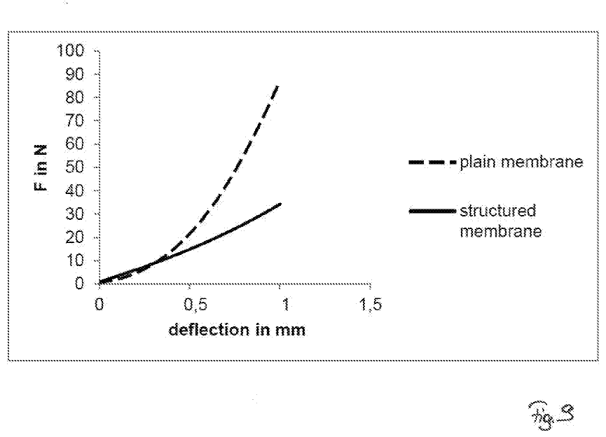

In FIG. 8, a further embodiment is shown, in which the spring element 64 is located above the membrane 28, thus on the side of the membrane 28 facing away from the outlet opening 20.

In this embodiment, the spring element 64 extends through a spring chamber 66, wherein the spring element 64 is supported on the adjustment section 30 of the membrane 28 as well as an interior housing section of the housing 12.

In the shown embodiment, the pressure chamber 44 is located between the membrane 28 and the outlet opening 20 so that the second side 42 of the membrane 28 is facing the pressure chamber 44 and serves as the active area.

Accordingly, the second side 42 of the membrane 28 is facing the pressure chamber 44 in this embodiment. Alternatively, this side can also be regarded as the first side so that the second side of the membrane 28 is facing the spring chamber 66.

The spring element 64 acts on the membrane in the closed position, wherein the spring element 64 is located in the spring chamber 66 that is opposite the pressure chamber 44.

In this embodiment, the compression of the spring element 64 counter to its spring force occurs by applying compressed air. If the pneumatic actuation unit 14, in particular the control element 58, is actuated to produce a fluid connection between the air supply channel 48 and the pressure chamber 44, overpressure is applied to the membrane 28 counter to the spring force of the spring element 64 in its starting position, thereby releasing the outlet opening 20 so that the adhesive can exit via the media channel 18 and the outlet opening 20. In this case, the membrane 28 is moved into the spring chamber 66 and thus the spring chamber 66 can also be regarded as the movement chamber 52 in which the membrane 28 moves when actuating the pneumatic actuation unit 14. The membrane 28 and the valve element 24 coupled with the membrane 28 are in their upper end position.

In this respect, the functioning is reversed in the case of the embodiment shown in FIG. 8 vis-à-vis the previously shown embodiments as the compressed air is used to act upon the valve element 24 coupled to the membrane 28 in its open position. The generation of momentums is caused by the actuation of the control element 58 through a venting the pressure chamber 44. In doing so, the spring element 64 destresses.

As previously explained, the circular membrane 28 comprises in general a structuring 34 in the form of a wave geometry which comprises concentric waves in an annular structural section 32 which radially encloses the centrally located adjustment section 30.

The wave geometry can comprise concentric, semi-circularly formed waves, thereby making an approximately linear force-distance curve of the structured membrane 28 possible, in which the corresponding strokes can be generated without any plastic deformation. This is shown clearly in FIG. 9, in which the force-distance curve of a structured membrane 28 and that of a smooth membrane are plotted in a diagram.

However, in the case of the structured membrane 28, the plastic deformation is avoided during the pulse operation by means of the embossing, thereby increasing the longevity of the actuator 26.

In addition, the radial stress in the structural section 32 of the membrane 28 caused by the deformation ensures an unequivocal zero position of the membrane 28 in which the membrane 28 resets if the pneumatic load is interrupted by the pneumatic actuation unit 14.

As already explained earlier, the waves of the structuring 34, thus the wave peaks 38 and the wave troughs 36, have a predefined height or depth in relation to the middle plane M. With the increasing depth of the embossed wave troughs 36 or increasing height of the wave peaks 38, the rigidity of the structural section 32 of the membrane 28 increases, but also the possible flexure of the membrane 28 as more material is available for the change of form. In this respect, the stroke behavior of the membrane 28 can be set via the depth or height of the waves of the structuring 34.

In the shown embodiments, several waves are provided, thus several consecutive wave troughs 36 and wave peaks 38, that generally comprise a relatively low depth and height in relation to the middle plane M of the membrane 28. The individual waves, considered individually, thus only permit a small flexure of the membrane 28 in comparison to a wave trough 36 with a large depth or a wave peak 38 with a large height. Similarly, the individual waves, considered individually, only make a small contribution to the rigidity of the membrane 28.

As several wave troughs 36 and wave peaks 38 are however provided, the total result is a favorable rigidity in combination with a sufficiently high flexure of the membrane 28 so that an adequate minimum stroke of the valve element 24 coupled to the membrane 28 can be attained.

This embodiment of the membrane 28 permits, for example, a minimum stroke of more than 0.1 mm, preferably more than 0.3 mm, in the metering device 10 according to the invention

By adapting the aforementioned ratios, other minimum strokes can be easily set for the valve element 24.

The membrane 28 comprises in particular a modulus of elasticity of more than 50 GPa, preferably 100 GPa and particularly preferably 150 GPa in order to be able to ensure the desired properties with regards to rigidity and flexure.

Both the geometrical configuration and the selection of the material of the membrane 28 are important for achieving a high speed in adjusting the valve element 24.

Although very flexible membranes 28 would have the advantage of a force-distance curve that is favorable for the generation of momentums, they would result in an undefined deformation of the membrane 28 when applying a pneumatic force by means of the pneumatic actuation unit 14 and consequently result in an undefined metering process, which is undesirable.

However, membranes that are too rigid comprise a spring constant that is too high and would require very high input pressures for the corresponding deformation and thus are also unsuitable.

Metallic materials are preferred as materials for the membrane 28 as they can permanently withstand high stresses without deforming plastically. In this respect, a metallic membrane 28 has a positive impact on the longevity of the actuator 26.

In particular, high-grade steel is suitable for use in the metering device 10 according to the invention owing to its corrosion resistance.

Other materials that provide the required rigidity together with simultaneously sufficient longevity can also be provided for the membrane 28.

In addition to the material of the membrane 28, the membrane thickness has a strong impact on the rigidity of the membrane 28 and thus on the behavior of the membrane 28 during operation.

In principle, the thinner the material of the membrane 28 chosen, the lower the resulting rigidity of the membrane 28 is. In contrast, the thicker the material of the membrane 28 is, the higher the rigidity and thus also the spring constant of the membrane 28.

As already mentioned, during the production of the membrane 28 by embossing the waves, thus the wave troughs 36 and the wave peaks 38, there is an increase in the material surface with the simultaneous change of form regarding the thickness of the membrane 28 in the structural section 32.

The deeper the wave trough 36 or the higher the wave peak 38 is, the greater the material is constricted in the direction of the thickness of the membrane 28. In certain cases, the membrane 28 can break at the point of the smallest membrane thickness. A minimal material thickness during the embossing of the structural section 32 or the structuring 34 must be taken into consideration to avoid this. The maximum membrane thickness in the direction of the membrane thickness is simultaneously limited by the dimension of the modulus of elasticity in order to be able to realize the desired flexure, as already described above.

The thickness of the membrane 28 is, for example, smaller than 500 μm, preferably smaller than 350 μm, particularly smaller than 250 μm in order to limit the dimension of the modulus of elasticity accordingly. Simultaneously, the thickness of the membrane 28 is selected larger than 10 μm, preferably larger than 25 μm, particularly larger than 50 μm in order to ensure a sufficiently large material thickness.

In general, the parameters of the structured membrane 28, thus the structuring 34, the material, the thickness and the diameter selected in such a way that the membrane 28 has a spring constant that is less than 100 N/mm, but larger than 5 N/mm.

In principle, the lower the spring constant of the membrane 28 is, the higher acceleration of the valve element 24 is achievable in the effective direction (direction of effective motion). At the same time, however, the venting or reset speed of the membrane 28 and thus also that of the valve element 24 coupled to the membrane 28 are impaired.

The greater the spring constant of membrane 28 is, the more the acceleration of the valve element 24 decreases when actuating the actuator 26, simultaneously, however, the venting speed is improved through the increased recovery of the membrane 28 and thus that of the valve element 24.

The range of the spring constant between 5 N/mm and 100 N/mm described above enables a right amount of valve element speed and venting speed and thus a favorable metering frequency larger than 100 Hz, preferably larger than 200 Hz for the metering of the liquid media.

The metering device 10 includes to this end a control device 68 that is connected to the pneumatic actuator unit 14 in signal-transmitting manner, as is shown schematically in FIG. 1. The pneumatic actuation unit 14 thus receives corresponding control commands from the control device 68 in order to reduce or increase the pressure pneumatically.

The pneumatic actuation unit 14 pressurizes the membrane with compressed air as a result of the control commands received, by means of which the pneumatic actuation unit 14 adjusts the membrane 28 and thus also adjusts the valve element 24 coupled to the membrane 28. A momentum is exerted on the medium to be metered via the valve element 24 coupled to the membrane 28.

The valve element 24 extends through the sealing element 54, wherein the valve element 24 can moves accordingly pulsatingly to generate momentums with high metering frequencies that can be transmitted to the medium to be metered. In this respect, a momentum sequence is exerted on the medium to be metered to be able to meter very small amounts of the medium to be metered.

In the embodiment of the membrane 28 described, input pressures are needed that are smaller than 25 bar, preferably smaller than 15 bar, particularly smaller than 10 bar, for example less than 8 bar. In this respect, small input pressures suffice to enable metering with the metering device 10.

In general, the metering device 10 can be stored on a moveable unit, for example a unit moveable in three dimensions, so that different positions on a substrate can be moved to on which the medium is dispensed. This moveable unit can be deployed by a manufacturing robot or a computer-controlled machine.

Alternatively, the metering device 10 can be also fixed in position, wherein the substrate is moved relative to the metering device 10. To this end, the substrate can be moved on a table, in particular in a plane.

The metering device 10 can be used in various use cases. This includes inter alia contactless metering of individual drops as well as several consecutive individual drops on a corresponding substrate, where both the metering device 10 and the substrate can be moved. By coordinating the metering frequency and travel speed, beads can be generated in different volumes and/or geometries. The metering of the medium can also be varied in the form of individual drops as well as series of drops through metering parameters such as medium pressure, momentum time and pause times.

Potential metering media include, for example, adhesives, sealants, coatings, grouting materials, lubricants, solvents and/or cleaning materials.

The smallest drops can be metered in clearances, gaps or undercuts of the substrate through the option of contactless metering.

The metering device 10 may be a metering device for adhesives which is provided for the metering of adhesives.

In this respect, the metering device 10 can be used as a metering device for adhesives.

1. Metering device (10) for metering liquid media comprising a valve element (24) and a valve seat (22) that is allocated to the valve element (24), wherein the valve element (24) in a closed position of the metering device (10) blocks an opening (20) that is allocated to the valve seat (22), through said opening (20) the liquid medium flows in an open position of the metering device (10), wherein the metering device (10) includes a membrane (28) serving as an actuator (26) that is designed rigidly flexibly and is coupled to the valve element (24) in order to adjust the valve element (24), wherein the membrane (28) comprises at least partially a structuring (34) and wherein the metering device (10) includes a pneumatic actuator unit (14) so that the membrane (28) serving as an actuator (26) is operated pneumatically, wherein the membrane (28) is sealed against the medium to be metered.

2. Metering device (10) according to claim 1, characterized in that the membrane (28) comprises a first side (40) and a second side (42) that is opposite the first side (40), wherein the first side (42) is allocated to a pressure chamber (44) and/or wherein the second side (42) is allocated to a movement chamber (52), in particular wherein the membrane (28) is sealed against the medium to be metered.

3. Metering device (10) according to claim 1, characterized in that the pneumatic actuator unit (14) is configured to apply compressed air to the membrane (28) so that the pneumatic actuator unit (14) exerts a momentum on the medium to be metered.

4. Metering device (10) according to claim 1, characterized in that the membrane (28) is formed, in particular embossed, in the area of the structuring (34).

5. Metering device (10) according to claim 1, characterized in that the pressure chamber (44) and/or the movement chamber (52) comprise a counter structuring (60) on a side opposite to the membrane (28), said counter structuring (60) being complementary to the structuring (34) of the membrane (28).

6. Metering device (10) according to claim 1, characterized in that the membrane (28) is undulated, wherein the wave peaks (38) and wave troughs (36) alternate in each case.

7. Metering device (10) according to claim 1, characterized in that the membrane (28) comprises a modulus of elasticity of greater than 50 GPa, preferably greater than 100 GPa and particularly preferably greater than 150 GPa, and/or that the spring constant of the membrane (28) is between 5 N/mm and 100 N/mm.

8. Metering device (10) according to claim 1, characterized in that the membrane is substantially circular and/or continuously closed, in particular wherein the membrane (28) has a concentric wave geometry.

9. Metering device (10) according to claim 1, characterized in that the membrane (28) comprises a centrally provided adjustment section (30) and/or a structural section (32), particularly wherein the valve element (24) is coupled to the membrane (28) in the area of the adjustment section (30).

10. Metering device (10) according to claim 1, characterized in that a spring element (64) is provided, via which the membrane (28) is prestressed, in particular wherein the spring element (64) prestresses the membrane (28) in the open position of the metering device (10) or in the closed position of the metering device (10).

11. Method for metering liquid media in said method compressed air is applied to a membrane (28) of a metering device (10) serving as an actuator (26) via a pneumatically operated actuator unit (14) so that the membrane (28) and a valve element (24) that is coupled to the membrane (28) and allocated to the valve seat (22) of the metering device (10) are pneumatically adjusted in order to open or lock an opening (20) allocated to the valve seat (22).
